(19) United States
(12) Patent Application Publication
(10) Pub. No.: US 2007/0118466 A1
(43) Pub. Date: May 24, 2007

(54) MANAGED TRADING PROCESS

(76) Inventor: Manish Worlikar, Clifton, NJ (US)

Correspondence Address: Mr. Walter J. Tencza Jr., Suite 3, 10 Station Place, Metuchen, NJ, 08840, US

(21) Appl. No.: 11/671,100

(22) Filed: Feb. 5, 2007

(51) Int. Cl. G06Q 40/00

(52) U.S. Cl. 705/37

(57) ABSTRACT

About ninety percent of traders who trade financial instruments lose money trading in a real account, whereas a vast majority of them make money trading the simulated account. The reasons for losing money in real accounts may be related to: (a) fear, (b) greed (c) stress (d) no proper money management (improper position size). An apparatus and method is provided for dividing the trading task between two entities 1) trader and 2) money manager. The trader places the entry/exit trades while the money manager based on account performance decides which account (simulated/real) to be traded and how many contracts to be traded. Both trader and money manager work on the same order and their actions are isolated, decoupled, and independent from each other.

### FIELD OF THE INVENTION

This invention relates to improved methods and apparatus concerning the trading of financial securities.

### BACKGROUND OF THE INVENTION

About ninety percent of traders who trade financial instruments—such as financial securities, stocks, and bonds etc—lose money in their real accounts. A majority of these traders “make money” in simulated accounts, where no real money is invested.

The reasons for failure (losing money) in real accounts may or may not be limited to the following: (a) fear, (b) greed, (c) lack of discipline to follow a plan, (d) failure to control emotions, (e) failure to follow self-set rules, (f) psychological pressure, (g) stress, (h) failure to accept and limit losses (risk not justified), (i) over-trading, (j) uncontrolled ego of a trader, and (k) no proper money management (improper position size).

### SUMMARY OF THE INVENTION

One or more embodiments of the present invention remove and/or reduce a majority of the reasons financial instrument traders lose money in their real accounts. In at least one embodiment this is accomplished by dividing the trading task between two separate entities: a trader entity, and a money manager entity.

Typically trading of financial instruments is comprised of two tasks: one, when to buy or sell and two, how much money to invest per trade. One or more embodiments of the present invention provide a way to separate task one from task two. Task one may include an entry/exit signal strategy which is implemented by a trader clicking on a computer user Interface or by a trader's own automated signal generation strategy. Task two may typically include a money management strategy, which is implemented by a money manager, in which a set of rules and/or methods are applied manually or in an automated manner.

A trader takes the buy/sell signals (from task one) and the money manager decides which account (simulator/real) is traded and how many contracts are traded. The trader can opt for display of either an exact number of contracts/shares traded with an actual number of realized/un-realized profit loss numbers or default number of contracts/shares. For example, the trader can have displayed on a user computer monitor or user interface, one contract or one hundred shares and appropriately adjusted number of realized/un-realized profit loss numbers. One or more embodiments of the present invention employ a joint effort between a trader (which may be a human being and/or a computer) and a money manager (which may also be human being and/or a computer) to apply systematic methodology and make money in the markets.

### BRIEF DESCRIPTION OF THE DRAWINGS

FIG. 1 shows a diagram of a system, apparatus, and method in accordance with an embodiment of the present invention;

FIG. 2 shows a first image which can be displayed on a user interface of FIG. 1;.

FIG. 3 shows a second image, which can be displayed on the user interface of FIG. 1;

FIG. 4 shows a flow chart of a method in accordance with an embodiment of the present invention.

FIG. 5 shows a diagram of a system, apparatus, and method in accordance with another embodiment of the present invention; and

FIG. 6 shows a diagram of a system, apparatus, and method in accordance with another embodiment of the present invention.

### DETAILED DESCRIPTION OF THE DRAWINGS

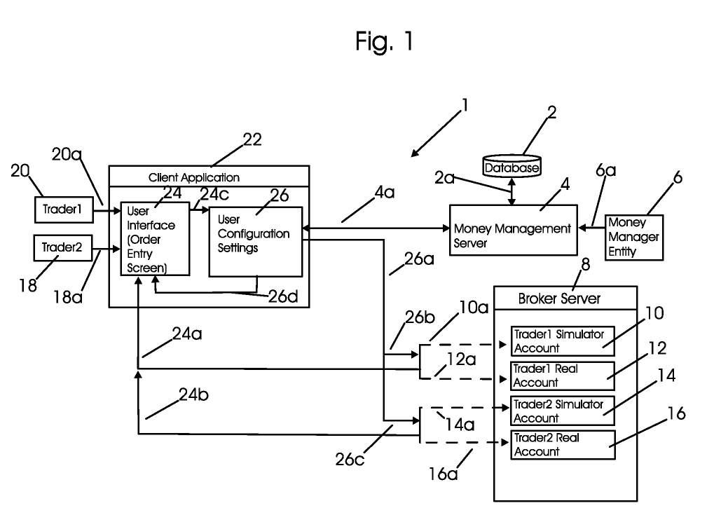

FIG. 1 shows a diagram of a system, apparatus, and method 1 in accordance with an embodiment of the present invention. The system, apparatus, and method 1 includes a database 2, a money management server 4, a money manager entity 6 (in actual implementation there may be and typically would be one or more money manager entity), a broker server 8, a trader2 or trader entity 18, a trader1 or trader entity 20 (in actual process implementation there may typically be one or more traders), a client application computer program based on broker API (Application Program Interface) or FIX (Financial Information eXchange) protocol running on client (trader) machine 22, a user interface or order entry computer monitor or screen 24, and user configuration settings component 26.

The broker server 8 includes trader1 simulator account 10, trader1 real account 12, trader2 simulator account 14, and trader2 real account 16. Any further number of trader real and simulator accounts may be part of broker server 8.

The client application computer 22 running a computer program based on broker API (Application Program Interface) or FIX (Financial Information Exchange) protocol or any other protocol used for communicating financial information includes a user interface 24 (such as a computer monitor, keyboard, and/or mouse) which a trader may use to enter trades. The actual trade parameters will typically be controlled by user configuration settings component 26 which are typically set by money manager 6. The client application computer program 22 can also be programmed to accept an automated order from a trader's automated trading system (ATS), which may be in a trader's computer, such as one of the trader entities 18 or 20 in FIG. 1—and/or may replace one of the trader entities 18 or 20 in FIG. 1, instead of a trader clicking on a computer mouse of the user interface 24 to place the trade.

The database 2 may be a computer memory database or a computer database application. The database 2 may include a user identification and a password for a user to logon to broker accounts (simulator and real). The database 2 may communicate with the money management server 4 via communications link 2a. The money management server 4 may be a computer server. The money management entity 6 may be a human being or a personal computer running an automated money management software program. The money management entity 6 may communicate by communications line 6a with the money management server 4.

The broker server 8 may be a computer server. Each of the accounts, 10, 12, 14, and 16 may include information stored on the broker server 8. Trader 18 and trader 20 may each be a human being who functions as a trader or may each be a personal computer running a software program (such as an automated trading system or ATS computer program,), to place trades. The client application computer 22, which may run a computer program based on broker API or FIX protocol may be a computer program running on a client or trader computer machine or server.

The traders 18 and 20 may be connected to the client application computer 22 by communications lines 18a and 20a, respectively. The user interface 24 may be connected by communications line 24a and 10a to account 10, by communications lines 24a and 12a to account 12, by communications lines 24b and 14a to account 14, and by communications line 24b and 16a to account 16. The user configuration settings component 26 (in a memory), may communicate with the user interface 24 via communications line 26d. The user interface 24 may also communicate with user configuration settings component 26 via communications line 24c. The money management server 4 may communicate with the user configuration settings component, via communications line 4a. The user configuration settings component may communicate with the broker server 8 via communications lines 26a, 26b, and 26c.

In operation, the computer program of the client application computer 22, based on broker API (application program interface) or FIX protocol 22, may be updated by the money management server 4 via a communications link 4a with money management rules during login into the client application computer 22 by a trader or before placing each trade. The money management server 4 may have stored therein user based settings, such as allowed trading instruments or securities, maximum stop loss per trade, and maximum stop loss per day and acct# (real or simulator) to which the next trade or all trades on that day should be placed.

Trader1 or entity 20 may provide orders via communications links 20a to the client application computer 22. The orders may be communicated through user interface 24, which may be a computer keyboard, computer mouse, order entry screen, an automated trade placing system, or any other interactive device. A status of the user configuration settings component 26 may be supplied back to the user interface 24, such as by being displayed on a monitor, through communications links 26d. For example, the status may include the maximum stop loss reached per day or per trade.

Trader1 or entity 20 may provide orders via user configuration settings component 26, and communications link 26a to the broker server 8 which may result in changes to the trader1 simulator account 10 (via communications link 10a) or to the trader1 real account 12 (via communications link 12a).

In one embodiment of the present invention, each task is divided per entity. The task of either trader1 (entity 20) or trader2 (entity 18) is just to provide entry/exit signals while the money manager entity 6 decides which account number (simulator or real) to route the order and how many contracts/shares to trade.

The trader entity, such as one of trader entities 18 and 20 in FIG. 1, will take an entry or exit signal, based on his/her own personal trading skills or based on an automated trading system (ATS) while the money manager entity 6 will take control of flow and order parameters, which may include, for example, account number routing and number of contracts/shares traded.

In one embodiment of the present invention, the trader entity, such as 18 or 20, focuses on making actual trades (based on his/her own methods, logic, and/or strategy, which may be proprietary) without worrying about which account (simulated or real) the order is routed to along with the number of contracts/shares traded. The money management entity 6, focuses on a value for a particular account having a particular account number, a performance for the account, a trading financial instrument, and a trading duration. The money management or money manager entity 6 can either employ an automated system or a manual strategy, either of which may be proprietary.

There is no obligation for each entity of entities 18, 20, and 6 to share his/her trading/money management strategy even though they work on the same order. Their actions are isolated, decoupled, and independent from each other.

The money management entity 6, shown in FIG. 1, may set some rules in the money management server 4, based on the amount of money or value in a particular account, the performance of a particular account, a financial trading instrument, a trading duration, or a maximum stop loss the particular account can handle for each trade and/or for each day.

The trading entity, such as 18 or 20, makes actual entry/exit signal decisions independent of a money manager entity, such as 6, but the stop loss, maximum daily loss, and maximum trade loss decisions may be determined by the money manager entity 6.

The relationship between the trader entity, such as 18 or 20, and the money manager entity, such as 6, can be one to one or many to one or many to many.

One way to reduce emotions/fear/greed is for a trader, such as one of entity 18 or 20, to write his/her own fully automated system where the trader himself/herself acts like a money manager, similar to money manager entity 6, but there are several disadvantages of a fully end to end automated trading system. Some of the disadvantages are: (a) not all strategies can be automated, (b) traders like to have more control on entry/exit signals rather than be completely dependent on an ATS (automated trading strategy), as market conditions can change drastically without any prior notice, (c) traders are not qualified to code their own ATS, and (d) traders may not want to share their strategy, with an ATS developer.

On the other hand, a trading process of various embodiments of the present invention takes advantage of a low stress simulation environment and is based on a trader's performance and directs the orders to a simulator or a real account along with controlling the trading instrument position size. It's a perfect blend of simulation and real trading.

The present trading process invention may not be beneficial to traders who are consistently profitable in the market and who have complete control of their emotions. These types of traders typically account for only ten percent or less of the total traders in the market.

The trader entity 18 or 20 to money manager entity 6 fee relationship may be (a) subscription based (/day, /week, /month, /year, etc.), (b) percentage based, (c) subscription and percentage based, (d) per trade, or (e) flat fee. The money manager entity 6 can charge a trader entity 18 or 20 with any of the above schemes or the money manager entity 6 and trader entity 18 or 20 can open a joint account and divide the proceeds of the account based on percentage owned.

One embodiment of the present invention may have the following architecture. The trader entity, such as 18 or 20 in FIG. 1, may follow his/her own proprietary trading strategy to enter and exit trades depending on the financial instrument traded. In this case the maximum stop loss per day and/or per trade is typically set by the money manager entity, such as 6 in FIG. 1. The trader entity, such as 18 or 20, can be automated or manual.

The money manager entity, such as 6, may follow his/her own proprietary money management strategy to set the maximum stop loss per day and/or per trade depending on the instrument traded value of particular account, performance of the particular account, and the trading duration. The money manager entity 6 may be automated or manual.

The computer software for the client application 22 in FIG. 1, may have the following specifications:
a) It can be browser based or a client .EXE installation.
b) It may be implemented based on a broker supplied API or FIX protocol or any other protocol used for communicating financial information.
c) The computer software for client application 22 can be custom tailored to one broker API or FIX protocol or can be a generic implementation able to connect to multiple broker server based on configuration settings.
d) The computer software for client application 22 can be programmed in any language supported by a broker's API or FIX protocol.
e) It can receive trade orders using the user interface or automated route.
f) The computer software for client application 22 can display an exact number of contracts/shares traded or just display default contracts/shares e.g. if defaulted contract size is one and ten NQ (Nasdaq futures) contracts are actually traded either in simulated or real account number then client application 22 can either display ten NQ (Nasdaq futures) contracts or just one contract to the trader entity 18 or 20 on the user interface 24. The money manager entity 6 typically has full knowledge of the number of contracts/shares traded and the account number to which they are directed. Trading duration can be day trading or swing trading.

In one embodiment of the present invention, a client application, such as 22 in FIG. 1, communicates with a money management server, such as 4, only once daily at login by a user into the client application 22, and/or during initiation of each trade. FIG. 1 shows an architecture of how one money manager 6, can set rules for various traders (trader1 (entity 20), trader2 (entity 18), etc.)

The following is an example with sample dummy numbers and will change based on the previous performance by a trader, instrument traded, value in a particular account, trading duration etc. These numbers are merely for demonstration of one hypothetical scenario.

Trader1 or entity 20 wants to day trade NQ (e-mini Nasdaq futures) and has his/her own trading strategy (automated or manual). The money manager entity 6 has his/her own set of methods/strategy (automated or manual). The Trader1 or entity 20 and the money manager 6 both open a joint account with a broker, such as one having a broker server 8, which exposes API or FIX protocol for automation, putting $3K (three thousand dollars) each, having a total account value of $6K (six thousand dollars). In this example, six thousand real dollars are placed in the real account, such as account 12 with broker server 8. Based on the value in a particular account and the financial instrument traded, in this case Nasdaq futures (NQ), the money manager entity 6 may come up with the following rules for Trader1 or entity 20:
a) The maximum daily loss (including all trades for the day) should not exceed $200. The client application 22 will display (for example on a computer monitor of client application 22) and message via the user interface 24 to Trader1 (entity 20) specifying when the maximum allowed daily loss has been met and no more new trades can be initiated on a particular day. The system may ask for a password after daily loss limit is reached and may ask if a trader still wants to place a new trade. The money manager 6 controls the password and may or may not tell the trader and the money manager 6 also has rights to change the password.
b) Ideally, trader1 should make around three trades with a maximum loss of $60.00 each, which is equal to three NQ points. (This may just be a suggestion by the money manager 6, but the Trader1 (entity 20) can decide based on his/her own strategy to do only one trade a day for a stop loss of $200.00).
c) Ideally, either the average profit target should be more than the average stop loss plus the commissions or the percentage of winning trades should be more than the percentage of losing trades.
d) The money manager 6 will inform and/or update trader1 via the user interface 24 or via other communication mediums such as email, phone etc. when there is a thirty percent increase or a thirty percent decrease in an account value or after five months that an investment has been owned whichever comes first.
e) Customizable option whether Trader1 (entity 20) wants to see on the user interface 24, the actual number of contracts/shares traded or just a default number of contracts/shares and appropriately adjusted realized and unrealized profit/loss numbers.

Only when both (the trader1 and the money manager entity 6) agree to all of the above similar conditions (in this example) then the trader1 (entity 20) and the money manager 6 can start trading. The rules/numbers shown above may change between each trader and money manager combination.

Based on the daily activity of trader1 (entity 20), the money manager 6, will apply his/her strategy and come up with the money management rules for the next day and update the money management server 4. The next day either during trader1 login or during each trade the money manager 6 rules will be read from the money manager server 4 and update the reference data (user configuration settings component 26) of the client application 22 of the trader1 (entity 20). The trader1 is now allowed to trade based on an agreed trading instrument with a maximum daily loss per day or per trade. The message will be displayed to the trader1 if he/she reaches the maximum loss limit set by the money manager 6.

The money manager entity 6 can direct the order to either a simulated account, such as 10, or a real account, such as 12. The trader1 (entity 20) will never see on the user interface 24 screen which account the order was actually routed to and the display of number of contracts/shares filled realized/un-realized profit loss numbers will depend on the customized option the trader has selected.

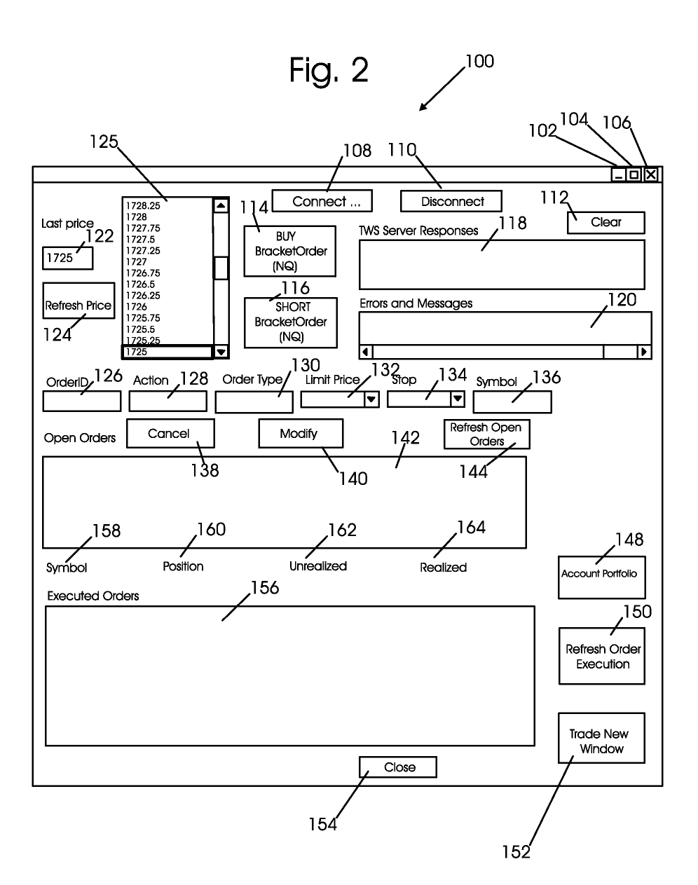

FIG. 2 shows a sample UI (user interface) screen or first image 100 which may appear on the user interface 24 of the client application 22. The user interface or first image 100 may change to a different image for each trader or instrument traded.

Various fields or windows will be described for the first image 100. Some of the fields can can be selected by placing a computer cursor over the field by moving a computer mouse, and then clicking the computer mouse while the cursor is over the particular field. Some of the fields may also be selected by touching them, such as on a computer touch screen. Some of the fields or windows may merely display information and may not be able to be selected.

The first image 100, shown in FIG. 2, may include fields or windows 108, 110, 112, 114, 116, 118, 120, 122, 124, 125, 126, 128, 130, 132, 134, 136, 138, 140, 142, 144, 146, 148, 150, 152, 154, 156, 158, 160, 162, and 164. Field 108 can be clicked on to connecting the broker server 8 to the client application 22, so that the client application 22 can receive quotes and place trade. orders. Field 110 can be clicked on to disconnect from the broker server 8 from the client application 22, so that the client application 22 will no longer receive quotes or be able to place trade orders.

Field 112 can be clicked on to clear any error/status messages previously received by a broker via the client application 22. Fields 114 or 116 can be clicked on to allow a trader to place a bracket order buy or short order, respectively. Typically a stop loss and profit target order will automatically be placed based on the agreement between the money manager 6 and a trader, such as entity 18 or 20.

The window 118 reports any broker server 8 response, such as for example, a status that an order has been filled. The window 120 reports any server errors e.g. connection lost between client application 22 and a broker server 8. The window 122 shows the last price of the currently selected/traded instrument. The field 124 can be clicked on to refresh window 125. with the price above and below the price in window 122.

In the window 125, a trader can select—the price and click on fields 114 or 116 to place the trade for that selected price. The fields 126, 128, 130, /132, 134, and 136 are used by a trader, such as entity 18 or 20 of FIG. 1, to modify an open order (some of these fields may be marked read only). Field 138 can be clicked on to cancel a selected open order. In case of a bracket order only the parent order may be able to cancelled, again this depends on the money manager 6 and trader agreement rules.

The field 140 can be clicked on to modify an existing order. The window 142 displays all open orders currently in the market. Field 144 when on clicked on refreshes the window 142 with current open orders in the market. Field 148 when clicked on refreshes windows 158, 160, 162 and 164 with current account values. Field 150 when clicked on refreshes window 156 with all executed orders for the current day. Field 152 can be clicked on if the trader wants to place an individual buy/sell order instead of bracket order. Field 154 can be clicked on to close the client application. Window 156 displays a current day's executed orders. Field 158 shows the symbol of a security or investment traded. Field 160 shows the current position traded (can be defaulted to 1 on UI (user interface), based on trader and MM (money manager) agreement). Field 162 shows currently unrealized profit loss. Field 164 shows current day's realized profit loss.

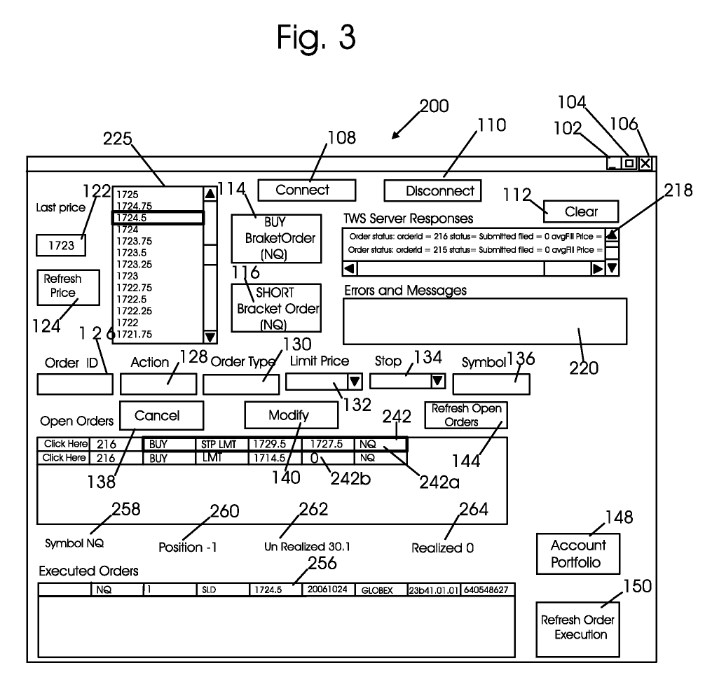

FIG. 3 shows a second image 200, which can be displayed on a computer monitor of user interface 24 of FIG. 1. FIG. 3 shows an example of a trader in a one nasdaq future short position with sample numbers. For the FIG. 3 example, a trader, such as entity 18 or 20, is in a short trade with a short entry at “1724.5” shown highlighted or outlined in window 225, and a stop loss set at “1727.5”, shown in the sixth column of a row 242a of table 242 and a profit target set at “1714.5”, shown in the fifth column of a row 242b of table 242. The fields or windows 108, 110, 112, 114, and 116 in FIG. 3 are the same as in FIG. 2. The field or window 218 in FIG. 3 corresponds to the window 118 in FIG. 2, but the window 218 contains different information, which is order status response from broker server for the open orders in 242. The field or window 220 of FIG. 3 corresponds to the field or window 120 of FIG. 2. Fields or windows 122, 124, 126, 128, 130, 132, 134, 136, 138, 140, and 144 are shown in both FIGS. 2 and 3. Window 242 in FIG. 3 corresponds to window 142 in FIG. 2 but window 242 shows different information, which is the stop and profit target orders to exit the current nasdaq future short position. Window 242 has rows 242a and 242b of data, which is the stop and profit target orders to exit the current nasdaq future short position. Fields or windows 148 and 150 are the same in FIGS. 2 and 3. Fields or windows 156, 158, 160, 162, and 164 in FIG. 2 correspond to FIG. 3 windows or fields 256, 258, 260, 262, and 264.

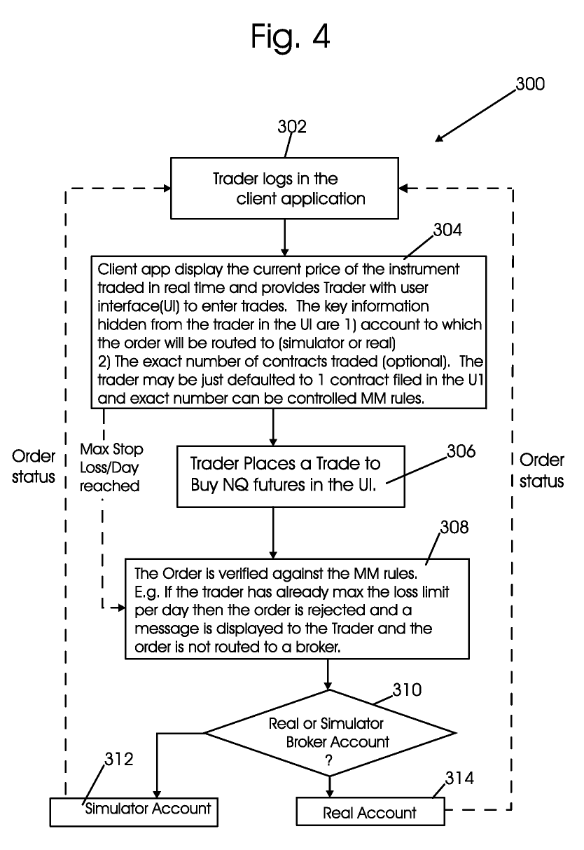

FIG. 4 shows a flow chart 300 of a method in accordance with an embodiment of the present invention. The method of FIG. 4 begins at step 302, wherein a trader logs into the computer program of the client application 22 of FIG. 1. Next at step 304, a processor (which may be thought of as being part of client application 22 along with user interface or computer monitor 24) running the computer program of the client application 22 displays a current price of a financial instrument traded in real time on the user interface or computer monitor 24. A trader, such as one of traders 18 and 20 can use the user interface 24 to enter trades The key information hidden from the trader in the user interface 24 is 1) the type of account to which the order will be routed (i.e real or simulated) and 2) the exact amount to be traded (such as the exact number of contracts, shares, or amount of money). Alternatively, the trader may be just defaulted to one contract filed in the user interface 24, and the exact number can be controlled by the rules set in the money management server 4.

At step 306, a trader places a trade to buy a number of futures, such as NQ (Nasdaq futures), using the user interface 24. At step 308, the order is verified against the money management rules, which are fed by money manager entity 6 into the user configuration settings component 26 of FIG. 1 For example, if the trader has already hit the maximum loss limit per day, then the order is rejected and a message is displayed on user interface 24 to the trader 18 or 20 and the order is not routed to a broker, such as broker server 8 of FIG. 1. At step 310, the user configuration settings component 26 determines from money management rules whether we are dealing with a real or simulated broker account. The order is routed to appropriate account and the order status is communicated back to the user interface 24, i.e. it is indicated on the user interface 24 whether the order was filled or some other status.

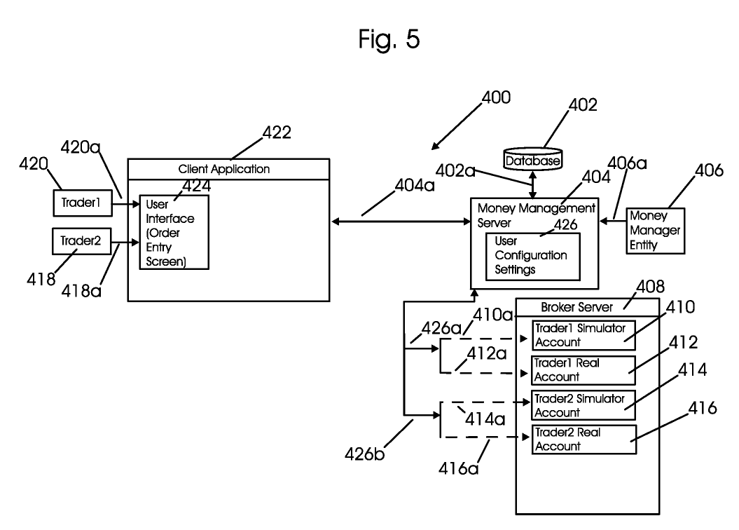

FIG. 5 shows a diagram of a system, apparatus, and method 400 in accordance with another embodiment of the present invention. In FIG. 5, various components, are similar to components in FIG. 1. The system, apparatus, and method 400 includes a database 402, a trader 418, trader 420, client application 422, which includes a user interface 424, a money management server 404, a money manager entity 406, and a broker server 408, similar to components 2, 18, 20, 22, 24, 4, 6, and 8, respectively, shown in FIG. 1. The broker server 408 includes simulator accounts 410 and 414 and real accounts 412 and 416 similar to simulator accounts 10, 14, 12, and 16, respectively, in FIG. 1. In FIG. 5, the client application 422 communicates with money management server 404 via communications channel or line 404a. The money management server 404 communicates with money manager entity 406 via communications line or channel 406a. The money management server 404 communicates with the broker server 408 accounts via communications lines 426a, 426b, 410a, 412a, 414a, and 416a. Traders 420 and 418 communicate via communications lines or channels 420a and 418a respectively, with client application 422.

In FIG. 5, a client application 422, which may similar client application 22, except as noted, typically always communicates with a money management server 404 and the money management server 404 in turn routes an order to a specific account, typically having an account number, after applying the appropriate money management rules. In this case the client application 422 need not be implemented in a broker API or FIX protocol, and the broker specific API or FIX protocol code should be implemented in the money management server 404.

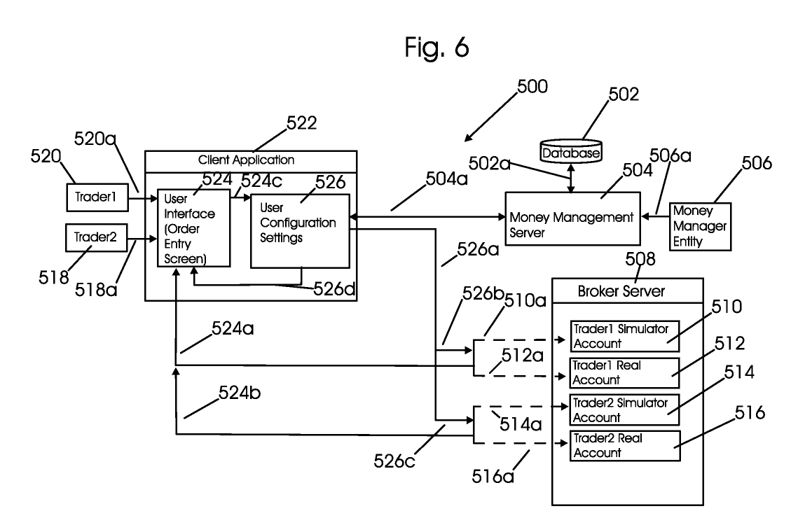

FIG. 6 shows a diagram of a system, apparatus, and method 500 in accordance with another embodiment of the present invention. In FIG. 6, various components, are similar to components in FIG. 1. The system, apparatus, and method 500 includes a database 502, a trader 518, trader 520, client application 522, which includes a user interface 524, a money management server 504, a money manager entity 506, and a broker server 508, similar to components 2, 18, 20, 22, 24, 4, 6, and 8, respectively, shown in FIG. 1. The broker server 508 includes simulator accounts 510 and 514 and real accounts 512 and 516 similar to simulator accounts 10, 14, 12, and 16, respectively, in FIG. 1. The money management server 504 communicates with money manager entity 506 via communications line or channel 506a. The money management server 504 communicates with the client application 522 via communications line 504a. Traders 520 and 518 communicate via communications lines or channels 520a and 518a respectively, with client application 522. The user configuration settings module 526 communicates with the broker server 508 via communications lines 526a, 526b, 526c, 510a, 512a, 514a, and 516a. The user interface 524 communicates with the broker server via communications lines 524a and 524b. In yet another embodiment, a trader entity, such as 518 or 520, either has to download everyday typically onto a trader's personal computer, which may be part of entity 518 or 520. (a) In the embodiment of FIG. 6, the money manager rules encrypted data either as a stream or a file format. The user config (configuration) settings data will then decrypt the data and apply the specified rules on the traders orders or (b) New .EXE client application program for application 522. This .EXE application program may typically have an entire broker application program interface code along with money management rules for each day.

In this way the computer program of the client application 522 will directly communicate via API or FIX protocol to Broker server 508, thus reducing delays communicating with money management server 504 while placing trades.

In one or more embodiments of the present invention, a money manager and/or money manager server, such as money management server 4 and money management entity 6 in FIG. 1, money management server 404 and money management entity 406 in FIG. 5, or money management server 504 and money management entity 506 in FIG. 6, may reverse a trader's received instructions for trading of a first set of financial instruments, if a trader has exceeded a threshold in losses on a previous second set of financial instruments. For example if the trader has lost more than $10,000.00 on a previous second set of financial instruments, such as a previous set of stocks, then when the trader requests to buy a first set of stocks, the money manager may instead sell (or short sell) the first set of stocks, in a brokerage account of the trader. Similarly, if the threshold is exceeded, when a “sell” order is received from the trader, the money manager or server, may cause a “buy” order to be executed in a brokerage account of the trader.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a client application computer;
a money management computer server;
wherein the client application computer is programmed to receive a first set of inputs from a first trader and the first set of inputs determines when a first investment is selected; and
wherein the money management computer server receives a second set of inputs from a money manager entity, wherein the second set of inputs from the money manager entity determines whether the first investment is selected for purchase in a real account or a simulated account.

2. The apparatus of claim 1 wherein
the money management computer server receives a third set of inputs from the money manager entity, wherein the third set of inputs from the money manager entity determines how many shares of the first investment are purchased.

3. An apparatus comprising:
a client application computers;
a money management computer servers;
wherein the client application computer is programmed to receive a first set of inputs from a first trader and the first set of inputs determines the selection of a first investment;
wherein the money management computer server receives a second set of inputs from a money manager entity, wherein the second set of inputs from the money manager entity provides a maximum loss limit, and wherein the money manager computer server purchases the first investment if the maximum loss limit has not been reached;
and wherein the money management computer server purchases the first investment in either a real account or a simulated account based on a third set of inputs from the money manager entity.

4. The apparatus of claim 3 wherein
the maximum loss limit is a daily maximum loss limit.

5. The apparatus of claim 3 wherein
the maximum loss limit is a weekly maximum loss limit.

6. The apparatus of claim 3 wherein
the maximum loss limit is a monthly maximum loss limit.

7. The apparatus of claim 3 wherein
the maximum loss limit is a per trade maximum loss limit.

8. A method comprising:
receiving a first set of inputs from a first trader;
selecting a first investment based on the first set of inputs;
receiving a second set of inputs from a money manager entity; and
determining whether the first investment will be purchased in a real account or a simulated account based on the second set of inputs.

9. The method of claim 8 further comprising
receiving a third set of inputs from the money manager entity; and
determining how many shares of the first investment are purchased based on the third set of inputs.

10. A method comprising:
selecting a first investment based on a first set of inputs from a first trader;
receiving a second set of inputs from a money manager entity, wherein the second set of inputs from the money manager entity provides a maximum loss limit;
and further comprising purchasing the first investment if the maximum loss limit has not been reached;
and wherein the first investment is purchased in either a real account or a simulated account based on a third set of inputs from the money manager entity.

11. The method of claim 10 wherein
the maximum loss limit is a daily maximum loss limit.

12. The method of claim 10 wherein
the maximum loss limit is a weekly maximum loss limit.

13. The method of claim 10 wherein
the maximum loss limit is a monthly maximum loss limit.

14. The method of claim 10 wherein
the maximum loss limit is a per trade maximum loss limit.

15. A method comprising
a financial instrument trading processes which includes a real financial trading activity and a simulated financial trading activity.

16. A method comprising
a financial instrument trading process in which information about a transaction involving trading of a financial instrument is hidden from a trader involved in the transaction.

17. The method of claim 16 wherein
the information includes identification of an account to which the transaction is applied.

18. The method of claim 16 wherein
the information includes the number of shares traded in the transaction.

19. A method comprising
a financial instrument trading process in which information about a financial instrument transaction is hidden from a money manager involved in the financial instrument transaction.

20. The method of claim 19 wherein
the information includes details concerning how the financial instrument transaction was started.

21. The method of claim 19 further comprising
providing signals from a trader involved in the financial instrument transaction for when the financial instrument transaction should take place; and
causing the money manager to set one or more rules which determine whether the signals from the trader are executed.

22. The method of claim 21 wherein
the signals are entry signals concerning when to buy the financial instrument.

23. The method of claim 21 wherein
the signals are exit signals concerning when to sell the financial instrument.

24. A method comprising
receiving instructions at a money manager from a trader regarding whether to buy or sell a first set of financial instruments;
determining whether the trader has exceeded a threshold of losses in buying or selling a second set of financial instruments; and
if the trader has exceeded the threshold, causing the money manager to buy the first set of financial instruments if the instructions from the trader indicate that the first set of financial instruments should be sold and causing the money manager to sell the first set of financial instruments if the instructions from the trader indicate that the first set of financial instruments should be bought;
and wherein the first set of financial instruments is bought or sold by the money manager in a brokerage account of the trader.
